(19) United States
(12) Patent Application Publication
(10) Pub. No.: US 2025/0209072 A1
(43) Pub. Date: Jun. 26, 2025

(54) DATA QUERY METHOD AND QUERY ENGINE

(71) Applicant: Alipay (Hangzhou) Information Technology Co., Ltd., Hangzhou (CN)

(72) Inventor: Litao LIN, Hangzhou (CN)

(21) Appl. No.: 18/971,741

(22) Filed: Dec. 6, 2024

(30) Foreign Application Priority Data
Dec. 25, 2023 (CN) 202311813478.1

(51) Int. Cl. G06F 16/2453; G06F 16/2452

(52) U.S. Cl. CPC G06F 16/24542; G06F 16/24526

(57) ABSTRACT

A data query method is performed by a query engine, and includes: receiving a user query, wherein the user query includes an SQL query statement and a Gremlin graph query statement embedded into the SQL query statement, the Gremlin graph query statement indicates to perform matching on one or more types of graph elements in a target graph, and the one or more types of graph elements include at least one of a point type, an edge type, or a path type; parsing the user query, to determine an execution plan; and performing a data query based on the execution plan.

### CROSS-REFERENCE TO RELATED APPLICATIONS

The present application is based upon and claims priority to Chinese Patent Application No. 202311813478.1, filed on Dec. 25, 2023, the content of which is incorporated herein by reference in its entirety.

### TECHNICAL FIELD

Embodiments of this specification relate to data query, and in particular, to a data query method and a query engine that are related to graph data.

### BACKGROUND

Most conventional databases are relational databases, and store data in a form of a table. For the relational database, data in the database can be queried and operated by using a structured query language (SQL). Due to intuition and rich functionality of the SQL, the SQL is a widely used query language in the database query field.

With development of big data and artificial intelligence, in more scenarios, data start to be recorded and processed in a form of a graph. For example, a user social relationship graph is usually constructed on a social platform, and a payment relationship graph is usually constructed on a payment platform. Therefore, a dedicated graph database is designed to store various graph data based on a characteristic of the graph data. A data storage form of the graph database is different from that of conventional relational data. Therefore, the SQL used to perform a query based on a table is hardly applicable to a query of the graph data.

In such a background, a dedicated graph query language is developed in the industry. A typical graph query language is a Gremlin graph query language. The graph query language depends on performing graph model abstraction on an association relationship, converting a data table into a point and an edge that are connected to each other, and then querying a complex association relationship through pattern matching on a graph. However, due to entirely different data types and query logic, Gremlin is hardly directly fused with the SQL, and Gremlin and the SQL cannot jointly implement a graph union query. This limits use scenarios of data query.

### SUMMARY

According to a first aspect, a data query method is performed by a target query engine. The method includes: receiving a user query, where the user query includes an SQL query statement and a Gremlin graph query statement embedded into the SQL query statement, the Gremlin graph query statement indicates to perform matching on one or more types of graph elements in a target graph, and the one or more types of graph elements include at least one of a point type, an edge type, or a path type; parsing the user query, to determine an execution plan; and performing a data query based on the execution plan.

According to a second aspect, a device operating as a query engine includes: a processor; and a memory storing instructions executable by the processor. The processor is configured to: receive a user query, where the user query includes an SQL query statement and a Gremlin graph query statement embedded into the SQL query statement, the Gremlin graph query statement indicates to perform matching on one or more types of graph elements in a target graph, and the one or more types of graph elements include at least one of a point type, an edge type, or a path type; parse the user query, to determine an execution plan; and perform a data query based on the execution plan.

According to a third aspect, a non-transitory computer-readable storage medium stores a computer program, and when the computer program is executed by a processor, the processor is caused to perform the method in the first aspect.

### BRIEF DESCRIPTION OF DRAWINGS

The following briefly describes the accompanying drawings of the present disclosure. Apparently, the accompanying drawings in the following description show merely example embodiments of the present disclosure.

FIG. 1 shows a scenario of a data query, according to an embodiment.

FIG. 2 is a flowchart illustrating a data query method, according to an embodiment.

FIG. 3 is a schematic diagram illustrating configuration of a query engine, according to an embodiment.

FIG. 4 is a schematic diagram illustrating configuration of a query engine, according to another embodiment.

FIG. 5 is a schematic structural diagram illustrating a query engine, according to an embodiment.

FIG. 6 is a schematic structural diagram illustrating a query engine, according to an embodiment.

### DETAILED DESCRIPTION OF EMBODIMENTS

Reference will now be made in detail to embodiments, examples of which are illustrated in the accompanying drawings. The following description refers to the accompanying drawings in which the same numbers in different drawings represent the same or similar elements unless otherwise represented. The described embodiments are merely examples rather than all the embodiments of the present disclosure.

Gremlin is a relatively mainstream graph query language, and is used to perform a query and an operation in a graph database. Gremlin is a part of an Apache TinkerPop graph computing framework, and supports various graphic databases, including Apache Cassandra, Neo4j, JanusGraph, etc. Graph data can be conveniently queried based on Gremlin, to perform modification, partial traversal, attribute filtering, etc. on a graph. Therefore, a complex graph query can be performed based on Gremlin.

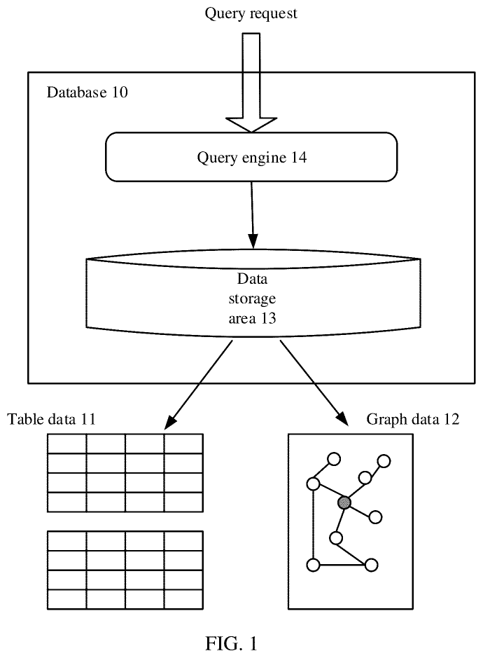

In some scenarios, a union query needs to be performed on graph data and table data. FIG. 1 shows a scenario of a data query, according to an embodiment. In this scenario, relational table data 11 and graph data 12 are stored in a data storage area 13 of a database 10. A user may want to perform a union query on the graph data and the table data by sending a query request to a query engine 14 of the database 10. For example, the user may want to perform a graph query based on some field values in a table, or further perform a table query based on a result of the graph query. For example, a mathematical score table, a friendship relationship graph, etc. are stored in the data storage area. The user may want to query the highest mathematical score of a second-hop friend of a specific user “Zhang San” based on this. Therefore, a union query needs to be performed based on the mathematical score table and a friend relationship graph.

However, a Gremlin graph query language is hardly fused with an SQL query, to perform the union query. One main difficulty in fusing the SQL and the graph query language is that types are incompatible in a system. The SQL only supports row and column fields and a few composite types such as an array and a mapping table. In Gremlin graph model abstraction, there is a composite type such as a point, an edge, and a path, and types cannot be converted into each other, so that syntax fusion of the SQL and the Gremlin graph query language cannot be implemented.

Another main difficulty in fusing the SQL and the Gremlin graph query language is that computing manners of the SQL and the Gremlin graph query language are entirely different. The SQL performs relationship computing by using a row and column as a center, and the Gremlin graph query language uses a graph algorithm in which a point is used as a center. The computing manners are distinguished, so that an actual execution plan can be hardly generated even if syntax fusion is implemented, and a syntax fusion description cannot be implemented.

In view of the above, embodiments of this specification provide a solution in which an SQL is fused with a Gremlin graph query. In the solution in the embodiments, type extension and mutual operator translation are performed to break through a barrier of an SQL query and the Gremlin graph query, to implement fusion of the SQL query and the Gremlin graph query. According to the embodiments, based on an SQL type system, basic types in a graph model are extended, and a point type, an edge type, and a path type are added. A result type generated through a graph query is covered by a point, an edge, and a path, to support a syntax fusion. For the computing manner, a mutual operator translation method in the embodiments nests a graph execution plan into an SQL execution plan, so that a graph query operator and an SQL query operator can be translated into each other. In such a solution, a syntax fusion manner is naturally generated. The above-mentioned type extension is superimposed, so that a user can use both the SQL and the Gremlin graph query language in a query statement.

The following describes a data query method and a query engine for implementing the above solution.

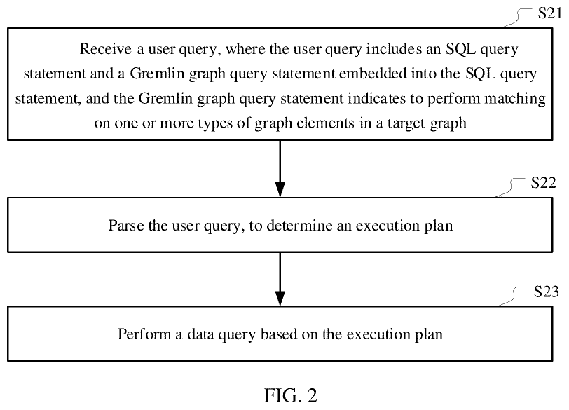

FIG. 2 is a flowchart illustrating a data query method, according to an embodiment. The query method is performed by a query engine, referred to herein as the target query engine, deployed in a database, and the database can store table data and graph data. The target query engine and the database can be implemented by any apparatus, device, platform, or a device cluster with a computing, storage, or processing capability. As shown in FIG. 2, the query method includes the following steps. Step S21: Receive a user query, where the user query includes an SQL query statement and a Gremlin graph query statement embedded into the SQL query statement, and the Gremlin graph query statement indicates to perform matching on one or more types of graph elements in a target graph. Step S22: Parse the user query, to determine an execution plan. Step S23: Perform a data query based on the execution plan. The following describes the query method in detail.

First, in step S21, the target query engine receives a query statement input by a user. The query statement is referred to as a user query. The user query includes an SQL query statement and a Gremlin graph query statement embedded into the SQL query statement, and the Gremlin graph query statement indicates to perform matching on the graph element in the target graph. The graph element can be at least one of a point, an edge, or a path. In other words, overall syntax of the user query satisfies syntax and architecture of the SQL, and the Gremlin graph query statement is embedded into the user query.

As described above, the target query engine supports data types of various graph elements through type extension. In an embodiment, data structures of various graph elements can be defined in the target query engine, and are used as extended data types. For example, according to a definition in the target query engine, a point type includes one or more fields; includes at least one identifier (ID) field which indicates a node ID; and can further include another field, for example, a label or a timestamp. Each field type can be any type in the SQL, for example, a character string or a floating point number. An edge type includes one or more fields; includes at least an identifier field of each node in a node pair including a source node and a destination node, which is used to reflect a relationship in which an edge is associated with a point; and can further include another field, for example, an edge direction, a label, or a timestamp. A path type is a composite type, and includes a type of consecutive points, a type of edges, or null values, which represent a point/edge entity that is passed through during graph traversal. A design of adding null values can be compatible with joint computing in relational algebra.

Because the target query engine supports the data types of various graph elements, the user is allowed to declare and use various graph elements in an SQL-based user query, and the graph element is used as a data object in a query process.

References can be made to the following query example 1:

```
      INSERT INTO tbl_out
      select g0.v1 as user, g0.v2 as topic, g0.e1 as likes
      from (
          select
forum_graph.V(uid).as(‘v1’).repeat(__.outE(‘follows’).has(‘creation_date’,lt(follow_time)).
inV( )).times(3).outE(‘likes’).as(‘e1’).inV( ).hasLabel(‘topic’).as(‘v2’).
    where( _.out(‘has_tag’).has(‘name’,tag_name)).path( ) as g0
from (
    select uid, tag_name, follow_time from request_user_table
    )
)
```

In the query example 1, the user query is an SQL query on the whole, and a Gremlin graph query statement with a forum graph. V prompt is inserted into the user query. Based on a Gremlin statement, query matching is performed on a graph g0, to find a point v1, a point v2, and an edge e1. Correspondingly, a point type (v1, v2) and an edge type (e1) are declared in the user query, and are used as data objects of query processing.

Based on the query example 1, as indicated by an initial SQL statement select g0.v1 as user, g0.v2 as topic, g0.e1 as likes, the user query requires to directly return matched graph elements, namely, point types v1 and v2, and an edge type e1.

In another example, further operation processing can be performed, by using the SQL statement, on a graph element found based on the Gremlin graph query statement.

References can be made to the following query example 2:

```
INSERT INTO tbl_result
SELECT
    v1_id,
    v2_id,
    weight
FROM (
    graph.V[...]
    RETURN v1.id as v1_id, e1. weight as weight, v2.id as v2_id
)
```

In the query example 2, [ . . . ] indicates that a query detail of the Gremlin graph query statement is omitted, but points v1 and v2 and an edge e1 need to be matched. Specific query details of this part can be the same as those of the query example 1. After the Gremlin graph query statement, the graph element found based on the Gremlin graph query statement is converted into row data by using a projection operation in an SQL statement Return. By using the projection operation, an id field (for example, v1.id) and a weight field of the edge e1 in the matched points are obtained, and form the row data. The formed row data can be inserted into a table for a subsequent SQL query and a subsequent operation.

In addition, the Gremlin graph query statement can further return a subgraph for subsequent SQL reference.

References can be made to the following query example 3:

insert into output_console
select g0.v.dis, concat2(‘__’, g0.v.status, ‘__’)
from (
select
g.V( ).has(‘status’, ‘active’).values( ) as g0
from users a where a.status != ‘B’
)
where g0.v.dis is not null

In the query example 3, the gremlin query statement returns a subgraph g0. Subsequently, in the SQL, a graph element in the subgraph g0 can be referenced by using a predetermined identifier. For example, a subgraph can be referenced by using a point separator identifier. For example, g0.v.dis indicates a field dis of a point v in the subgraph g0 is referenced. Similarly, g0.e.srcId can be used to represent that an srcId field of an edge e in the subgraph g0 is referenced. In this case, matching results of a graph query do not need to be projected one by one, and a graph element in a graph query result can be accessed merely in a reference manner.

In an embodiment, the target query engine further supports an external input parameter of the graph query. In other words, a parameter in the Gremlin graph query statement comes from another query. In view of this, such an input parameter relationship can be declared in the SQL statement by using a specific keyword and a parameter symbol. Based on syntax of the SQL statement, a preset keyword, e.g., WITH, can be used to declare an external input parameter of the graph query.

For example, references can be made to the following query example 4:

```
INSERT INTO tbl_result
SELECT
    v1_id,
    v2_id,
    weight
FROM (
    WITH p AS (
        SELECT * FROM (VALUES(1, 0.4), (4, 0.5)) AS t(id, weight)
    )
      graph.V[...where (e1.weight>p)]
    RETURN v1.id as v1_id, e1.weight as weight, v2.id as v2_id
)
```

In the query example 4, it is declared, by using a WITH keyword, that a parameter p involved in the Gremlin graph query statement comes from another query. In the example 3, the other query is an SQL query. In this case, when the SQL query and the Gremlin graph query need to be performed, the SQL query is performed to obtain a parameter value of the parameter p, and then the Gremlin graph query is performed based on the parameter value of p.

In another example, a query source of the external input parameter can also be an external function. In this case, the SQL query SELECT*FROM (VALUES(1, 0.4), (4, 0.5)) AS t(id, weight) in the example 3 only needs to be replaced with calling of the external function, for example, CALL func( . . . ) YIELD (p). Correspondingly, when a query is performed, the external function func needs to be called to receive a function operation result, so as to determine the value of the parameter p. Further, the graph query is performed based on the parameter value of p.

An external parameter is introduced by using the SQL statement, so that the user query is particularly applicable to a dynamic graph query. For example, the parameter p may be from a dynamic data source, and therefore, the value of p varies with time. Each time a graph query is performed, the parameter value of p is dynamically obtained, so that a current query parameter value can be obtained in real time, and the graph query is dynamically performed.

The above are examples of a user query in which a Gremlin statement is embedded in the SQL, where a context part embedded with the Gremlin statement is illustrated. In actual use, the user query can include a more complex SQL query statement before or after the Gremlin graph query statement, so that a result of a table query can be used for a graph query, or a result of a graph query can be integrated into a table for a further table query.

For the above-described user query in which the SQL is embedded with the Gremlin query statement, next, in step S22, the user query is parsed, to determine the execution plan, and in step S23, the data query is executed based on the execution plan.

For a process and a manner of determining the execution plan and performing the data query, there are two cases based on a setting of the target query engine.

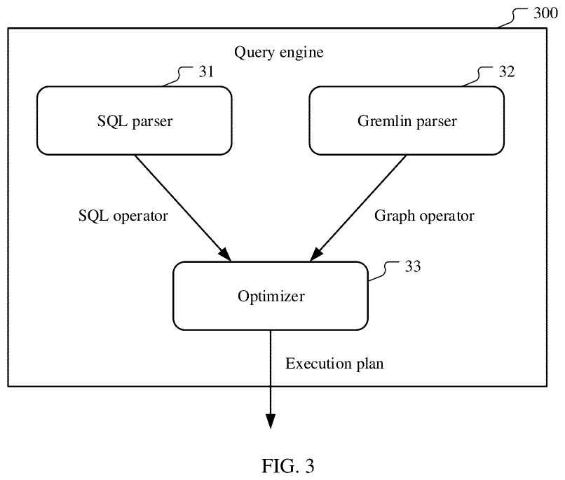

Case 1 is shown in FIG. 3, where a Gremlin parser is integrated into the target query engine. As shown in FIG. 3, a target query engine 300 includes an SQL parser 31, a Gremlin parser 32, and an optimizer 33. In this case, the target query engine 300 parses the SQL query statement in the user query by using the SQL parser 31, to obtain one or more first operators. The first operator represents a relationship operation for a table. For example, the one or more first operators can include various conventional relational algebra operators for a table in the SQL, for example, a Join operator, a Union operator, a Filter operator, and an Aggregate operator. The operators each correspond to an operation on the table in the SQL.

In addition, the Gremlin parser 32 further parses the Gremlin graph query statement in the user query, to obtain one or more second operators. The second operator represents a relationship operation for a graph, and is referred to as a graph operator.

The graph operator is a series of operators that are aligned with an SQL operator and that are designed by the target query engine for various operation designs in the graph query to better fuse execution plans of the SQL and Gremlin. The graph operators can be combined with each other, to express various semantics in the graph query, and each graph operator corresponds to an operator in the SQL, so that mutual operator translation and plan fusion can be implemented.

For example, many operators in the SQL are operated for a row. Correspondingly, a graph operator for performing a similar or corresponding operation on a path in the graph query can be designed. For example, the Union operator in the SQL represents to combine two pieces of input row data, to obtain a row data union set. Correspondingly, in the graph query, there can be a GraphUnion operator, indicating to combine two paths to obtain a path union set. The Filter operator in the SQL represents to filter a row (based on a specific filtering condition). Correspondingly, in the graph query, there can be a GraphFilter operator, indicating to filter a path. In the SQL, a Join operator for performing connection based on a row can correspond to a GraphJoin operator for performing connection based on a path. Table 1 below shows main operators involved in the graph query, meanings represented by the main operators, and corresponding meanings in SQLs, according to an embodiment.

TABLE 1

| | | Corresponding meaning in an |
|---|---|---|
| Operator name | Meaning in a graph | SQL |
| TraversalNode | Traverse points | Scan a table or join a point table |
| TraversalEdge | Traverse edges | Scan a table or join an edge table |
| LoopUntil | Cyclically traverse points | Cyclically join several |
| | and edges | point/edge table sequences |
| Distinct | De-duplication | Row de-duplication |
| Aggregate | Aggregation | Aggregate rows in a table |
| Extend | Extend a path | Extension projection |
| Filter | Filter paths | Filter rows |
| PathModify | Path mapping | Non-extension projection |
| Join | Path connection | Row connection |
| PathSort | Sort paths | Sort rows |
| Union | Path union | Row union |
| SubQueryStart | Subquery call | Nested query |
| TraversalVirtualEdge | Traverse virtual edges | Join a point table |

It can be understood that a prefix graph of the graph operator is omitted in Table 1.

In this way, the target query engine parses the Gremlin graph query statement into a combination of one or more graph operators, that is, the above-mentioned one or more second operators.

Therefore, the execution path can be optimized for a combination of the one or more first operators (SQL operators) and the one or more second operators (graph operators) by using the optimizer 33, to obtain the execution plan. That is, the optimizer 33 combines each SQL operator and the graph operator into a whole, to perform global optimization.

For example, an initial execution path can be obtained based on an original operator sequence obtained through parsing. Operator adjustment operations are performed, to obtain one or more candidate paths. The operator adjustment operations can include exchanging operator execution sequences, combining some operators, etc. For example, based on an original statement, the Gremlin graph query statement is embedded in the SQL, so the graph query can be used as an execution plan nested in the SQL execution plan. The adjustment operator can be used to push Filter computing in the SQL to a nested plan for execution, or can be used to extract a correspondence graph operator into a master execution plan. Some operators can be further combined, or even some redundant operators can be further deleted. Therefore, the candidate execution paths are obtained. The optimizer can evaluate an execution cost of each candidate path, and determine the optimized execution path based on the execution cost. Usually, the optimizer uses a path with a lower execution cost as the optimized execution path, and further as a final execution plan.

It can be understood that, because of a correspondence between the graph operator and the SQL operator, the graph operator and the SQL operator can be converted or translated into each other. In this way, the optimizer can uniformly construct one or more candidate paths, to conveniently compute the execution cost of each path, thereby globally optimizing execution paths.

Next, the target query engine can execute operations corresponding to all operators based on the execution plan, to execute a data query in the database. Further, the target query engine can return the query result to the user.

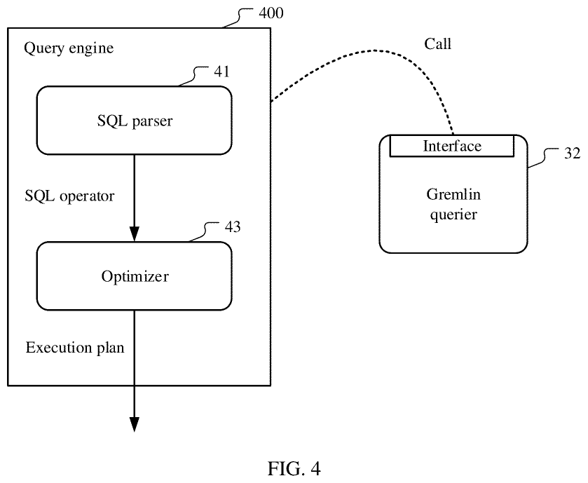

Case 2 of determining the execution plan and performing the data query is shown in FIG. 4, where the Gremlin querier is deployed outside the target query engine. As shown in FIG. 4, a target query engine 400 includes an SQL parser 41 and an optimizer 43. A Gremlin querier 42 is deployed outside the target query engine 400. The Gremlin querier 42 is configured to: parse the Gremlin query statement, and perform a query. The Gremlin querier 42 can externally provide an application interface (API) for calling.

In this case, the target query engine 400 parses the SQL query statement in the user query by using the SQL parser 41, to obtain one or more first operators. For the Gremlin query statement, the optimizer considers the Gremlin query statement as a fixed-cost and non-separable graph operation operator. Therefore, the optimizer 43 optimizes an execution path for a combination of the one or more first operators and the non-separable graph operation operator, to obtain an execution plan. In this process, the optimizer 43 can only optimize the SQL execution path, but may not optimize the execution path inside the graph query.

Although only the SQL part is parsed, the SQL parser 41 here is still different from a conventional SQL parser that only supports a table query operation. In the user query, graph element types, e.g., a point type, an edge type, and a path type, are usually declared in the SQL statement. Therefore, the SQL parser 41 needs to be able to identify and parse a corresponding data object based on a definition of the data structure of the graph element type in the target query engine. Correspondingly, the optimizer 43 also needs to be able to identify such a data object.

After the execution plan is determined, the target query engine performs the data query. In a data query process, for the SQL query part, an operation corresponding to each SQL operator is performed based on the execution plan. For the Gremlin graph query part, an interface provided by the Gremlin querier is called, to obtain a matching result of the Gremlin graph query statement. Further, the target query engine can determine the query result of the user query based on the matching result, and return the query result to the user.

In the above method, the target query engine extends the data type, to support to embed the Gremlin graph query statement into the SQL, thereby implementing the union query of graph data and table data. In some embodiments, the SQL operator and the graph operator correspond to each other and are translated into each other, so that the target query engine can fuse two execution paths, to perform global path optimization, and more efficiently perform the union query.

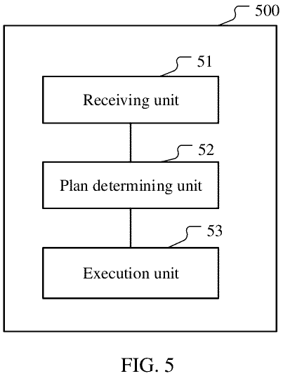

Embodiments of this specification also provide a query engine. FIG. 5 is a schematic structural diagram illustrating a query engine 500, according to an embodiment. The query engine 500 can be deployed in any device, platform, or device cluster with a data storage, computing, or processing capability. As shown in FIG. 5, the query engine 500 includes: a receiving unit 51, configured to receive a user query, where the user query includes an SQL query statement and a Gremlin graph query statement embedded into the SQL query statement, the Gremlin graph query statement indicates to perform matching on one or more types of graph elements in a target graph, and the one or more types of graph elements include at least one of a point type, an edge type, or a path type; a plan determining unit 52, configured to parse the user query, to determine an execution plan; and an execution unit 53, configured to perform a data query based on the execution plan.

In an embodiment, the user query requires to return a matched graph element.

In an embodiment, the SQL query statement in the user query includes a projection operation statement, to convert a graph element found based on the Gremlin graph query statement into row data.

In an embodiment, the query engine defines the following data structure: the point type includes one or more fields, and the one or more fields include at least an identifier field indicating a node ID; the edge type includes one or more fields, and the one or more fields include at least an identifier field of each node in a node pair including a source node and a destination node; and the path type includes a type of consecutive points, a type of edges, or null values.

In an embodiment, the plan determining unit 52 includes an SQL parser, a Gremlin parser, and an optimizer; the SQL parser is configured to parse the SQL query statement, to obtain one or more first operators, where the first operator represents a relationship operation for a table; the Gremlin parser is configured to parse the Gremlin graph query statement, to obtain one or more second operators, where the second operator represents a relationship operation for a graph; and the optimizer is configured to optimize an execution path for a combination of the one or more first operators and the one or more second operators, to obtain the execution plan.

In an embodiment, the optimizer is configured to: perform an operator adjustment operation, to obtain one or more candidate paths, where the operator adjustment operation includes one or more of the following: exchanging operator execution sequences and combining some operators; and determine the optimized execution path based on an execution cost of each candidate path.

In an embodiment, the plan determining unit 52 includes an SQL parser and an optimizer; and a Gremlin querier configured to perform a Gremlin query is deployed outside the target query engine 500. In this case, the SQL parser is configured to parse the SQL query statement, to obtain one or more first operators, where the first operator represents a relationship operation for a table; the optimizer is configured to optimize an execution path for a combination of the one or more first operators and a graph operation operator, to obtain the execution plan, where the graph operation operator corresponds to the Gremlin graph query statement, and is set to be a fixed-cost and non-separable operation.

In an embodiment, the execution unit 53 is configured to call an interface provided by the Gremlin querier, to obtain a matching result of the Gremlin graph query statement.

For detailed implementation of the query engine 500, references can be made to the above-described examples of the query method.

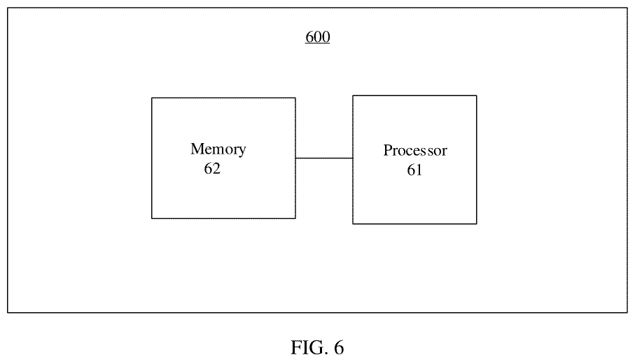

FIG. 6 is a schematic structural diagram illustrating a query engine 600, according to an embodiment. The query engine 600 can be deployed in any device, platform, or device cluster with a data storage, computing, or processing capability. As shown in FIG. 6, the query engine 600 includes: a processor 61 and a memory 62 storing instructions executable by the processor 61. The processor 61 is configured to receive a user query, where the user query includes an SQL query statement and a Gremlin graph query statement embedded into the SQL query statement, the Gremlin graph query statement indicates to perform matching on one or more types of graph elements in a target graph, and the one or more types of graph elements include at least one of a point type, an edge type, or a path type; parse the user query, to determine an execution plan; and perform a data query based on the execution plan.

In an embodiment, the user query requires to return a matched graph element.

In an embodiment, the SQL query statement in the user query includes a projection operation statement, to convert a graph element found based on the Gremlin graph query statement into row data.

In an embodiment, the Gremlin graph query statement returns a matched subgraph, and the SQL query statement references a graph element in the subgraph by using a predetermined identifier.

In an embodiment, the query engine defines the following data structure: the point type includes one or more fields, and the one or more fields include at least an identifier field indicating a node ID; the edge type includes one or more fields, and the one or more fields include at least an identifier field of each node in a node pair including a source node and a destination node; and the path type includes a type of consecutive points, a type of edges, or null values.

In an embodiment, the SQL query statement includes a first statement, the first statement includes a preset keyword for declaring an input parameter, a first parameter, and a second query, and the first parameter is used as a query parameter in the Gremlin graph query statement.

In an embodiment, performing the data query includes: performing the second query, and determining a parameter value of the first parameter based on a result of the second query; and performing matching in the Gremlin graph query statement based on the parameter value of the first parameter.

In an embodiment, the second query is an SQL query.

In an embodiment, the second query is an external function, and performing the second query includes: calling the external function, and receiving a function operation result.

In an embodiment, the processor 61 is configured to implement an SQL parser, a Gremlin parser, and an optimizer in the query engine 600; the SQL parser is configured to parse the SQL query statement, to obtain one or more first operators, where the first operator represents a relationship operation for a table; the Gremlin parser is configured to parse the Gremlin graph query statement, to obtain one or more second operators, where the second operator represents a relationship operation for a graph; and the optimizer is configured to optimize an execution path for a combination of the one or more first operators and the one or more second operators, to obtain the execution plan.

In an embodiment, the optimizer is configured to: perform an operator adjustment operation, to obtain one or more candidate paths, where the operator adjustment operation includes one or more of the following: exchanging operator execution sequences and combining some operators; and determine the optimized execution path based on an execution cost of each candidate path.

In an embodiment, the processor 61 is configured to implement an SQL parser and an optimizer in the query engine 600; and a Gremlin querier configured to perform a Gremlin query is deployed outside the target query engine 600. The SQL parser is configured to parse the SQL query statement, to obtain one or more first operators, where the first operator represents a relationship operation for a table; the optimizer is configured to optimize an execution path for a combination of the one or more first operators and a graph operation operator, to obtain the execution plan, where the graph operation operator corresponds to the Gremlin graph query statement, and is set to be a fixed-cost and non-separable operation.

In an embodiment, the processor 61 is configured to call an interface provided by the Gremlin querier, to obtain a matching result of the Gremlin graph query statement.

Embodiments of this specification further provide a non-transitory computer-readable storage medium. The computer-readable storage medium stores a computer program, and when the computer program is executed by a processor, the processor is caused to perform the method described above.

In the embodiments of this specification, the target query engine extends a data type, to support to embed a Gremlin graph query statement into an SQL, thereby implementing a union query of graph data and table data. An SQL operator and a graph operator may correspond to each other and be translated into each other, so that the target query engine can fuse two execution paths, to perform global path optimization, and more efficiently perform the union query.

In the above described embodiments, each unit can be implemented by hardware, software, or a combination thereof. When the unit is implemented by software, the software can be stored in a computer-readable medium or transmitted as one or more instructions to implement corresponding functions.

It should be understood that the above descriptions are merely example embodiments of the present disclosure, and are not intended to limit the protection scope of this disclosure. Any modification, equivalent replacement, improvement, etc. made based on the embodiments of this disclosure shall fall within the protection scope of this disclosure.

What is claimed is:

1. A data query method, performed by a query engine, wherein the method comprises:
receiving a user query, wherein the user query comprises an SQL query statement and a Gremlin graph query statement embedded into the SQL query statement, the Gremlin graph query statement indicates to perform matching on one or more types of graph elements in a target graph, and the one or more types of graph elements comprise at least one of a point type, an edge type, or a path type;
parsing the user query, to determine an execution plan; and
performing a data query based on the execution plan.

2. The method according to claim 1, wherein the user query requires to return a matched graph element.

3. The method according to claim 1, wherein the SQL query statement comprises a projection operation statement, to convert a graph element found based on the Gremlin graph query statement into row data.

4. The method according to claim 1, wherein the Gremlin graph query statement returns a matched subgraph, and the SQL query statement references a graph element in the subgraph by using a predetermined identifier.

5. The method according to claim 1, wherein the query engine defines following data structure:
the point type comprising one or more fields, and the one or more fields comprising at least an identifier field indicating a node ID;
the edge type comprising one or more fields, and the one or more fields comprising at least an identifier field of each node in a node pair comprising a source node and a destination node; and
the path type comprising a type of consecutive points, a type of edges, or null values.

6. The method according to claim 1, wherein the SQL query statement comprises a first statement, the first statement comprises a preset keyword for declaring an input parameter, a first parameter, and a second query, and the first parameter is used as a query parameter in the Gremlin graph query statement.

7. The method according to claim 6, wherein the performing the data query comprises:
performing the second query, and determining a parameter value of the first parameter based on a result of the second query; and
performing matching in the Gremlin graph query statement based on the parameter value of the first parameter.

8. The method according to claim 7, wherein the second query is an SQL query.

9. The method according to claim 7, wherein the second query is an external function, and performing the second query comprises: calling the external function, and receiving a function operation result.

10. The method according to claim 1, wherein the query engine comprises an SQL parser, a Gremlin parser, and an optimizer; and
the parsing the user query, to determine the execution plan comprises:
parsing the SQL query statement by using the SQL parser, to obtain one or more first operators, wherein the one or more first operators represent a relationship operation for a table;
parsing the Gremlin graph query statement by using the Gremlin parser, to obtain one or more second operators, wherein the one or more second operators represent a relationship operation for a graph; and
optimizing, by using the optimizer, an execution path for a combination of the one or more first operators and the one or more second operators, to obtain the execution plan.

11. The method according to claim 10, wherein the optimizing the execution path for the combination of the one or more first operators and the one or more second operators comprises:
performing an operator adjustment operation, to obtain one or more candidate paths, wherein the operator adjustment operation comprises one or more of: exchanging operator execution sequences and combining some operators, and operators on which the operator adjustment operation is performed comprise the first operator and the second operator; and
determining the optimized execution path based on an execution cost of each candidate path.

12. The method according to claim 1, wherein the query engine comprises an SQL parser and an optimizer, and a Gremlin querier configured to perform a Gremlin query is deployed outside the query engine; and
the parsing the user query, to determine the execution plan comprises:
parsing the SQL query statement by using the SQL parser, to obtain one or more first operators, wherein the one or more first operators represent a relationship operation for a table; and
optimizing, by using the optimizer, an execution path for a combination of the one or more first operators and a graph operation operator, to obtain the execution plan, wherein the graph operation operator corresponds to the Gremlin graph query statement, and is set to be a fixed-cost and non-separable operation.

13. The method according to claim 12, wherein the performing the data query based on the execution plan comprises:
calling an interface provided by the Gremlin querier, to obtain a matching result of the Gremlin graph query statement.

14. A device operating as a query engine, comprising:
a processor; and
a memory storing instructions executable by the processor;
wherein the processor is configured to:
receive a user query, wherein the user query comprises an SQL query statement and a Gremlin graph query statement embedded into the SQL query statement, the Gremlin graph query statement indicates to perform matching on one or more types of graph elements in a target graph, and the one or more types of graph elements comprise at least one of a point type, an edge type, or a path type;
parse the user query, to determine an execution plan; and
perform a data query based on the execution plan.

15. The device according to claim 14, wherein the SQL query statement comprises a projection operation statement, to convert a graph element found based on the Gremlin graph query statement into row data.

16. The device according to claim 14, wherein the Gremlin graph query statement returns a matched subgraph, and the SQL query statement references a graph element in the subgraph by using a predetermined identifier.

17. The device according to claim 14, wherein the SQL query statement comprises a first statement, the first statement comprises a preset keyword for declaring an input parameter, a first parameter, and a second query, and the first parameter is used as a query parameter in the Gremlin graph query statement; and
the processor is further configured to:
perform the second query, and determine a parameter value of the first parameter based on a result of the second query; and
perform matching in the Gremlin graph query statement based on the parameter value of the first parameter.

18. The device according to claim 14, wherein the processor is configured to implement an SQL parser, a Gremlin parser, and an optimizer; and
the processor is further configured to:
parse the SQL query statement by using the SQL parser, to obtain one or more first operators, wherein the one or more first operators represent a relationship operation for a table;
parse the Gremlin graph query statement by using the Gremlin parser, to obtain one or more second operators, wherein the one or more second operators represent a relationship operation for a graph; and
optimize, by using the optimizer, an execution path for a combination of the one or more first operators and the one or more second operators, to obtain the execution plan.

19. The device according to claim 18, wherein the processor is further configured to:
perform an operator adjustment operation, to obtain one or more candidate paths, wherein the operator adjustment operation comprises one or more of: exchanging operator execution sequences and combining some operators, and operators on which the operator adjustment operation is performed comprise at least one of the one or more first operators and at least one of the one or more second operators; and
determine the optimized execution path based on an execution cost of each candidate path.

20. The device according to claim 14, wherein the processor is configured to implement an SQL parser and an optimizer, and a Gremlin querier configured to perform a Gremlin query is deployed outside the query engine; and
the processor is further configured to:
parse the SQL query statement by using the SQL parser, to obtain one or more first operators, wherein the one or more first operators represent a relationship operation for a table; and
optimize, by using the optimizer, an execution path for a combination of the one or more first operators and a graph operation operator, to obtain the execution plan, wherein the graph operation operator corresponds to the Gremlin graph query statement, and is set to be a fixed-cost and non-separable operation.
